(19) United States
(12) Patent Application Publication
(10) Pub. No.: US 2023/0073593 A1
(43) Pub. Date: Mar. 9, 2023

(54) Protective Card Case and Grading System

(71) Applicants: William Blom, Cleveland, TN (US); Edwin Hunter, Cleveland, TN (US)

(72) Inventors: William Blom, Cleveland, TN (US); Edwin Hunter, Cleveland, TN (US)

(21) Appl. No.: 17/897,404

(22) Filed: Aug. 29, 2022

Related U.S. Application Data
(63) Continuation of application No. 29/806,829, filed on Sep. 7, 2021.
Application No. 29/806,829 is a continuation of application No. 29/807,690, filed on Sep. 14, 2021.
Application No. 29/807,690 is a continuation of application No. 29/810,161, filed on Oct. 1, 2021.
(60) Provisional application No. 63/251,783, filed on Oct. 4, 2021.

(51) Int. Cl. G06Q 30/02; A45C 11/18; A45C 13/00

(52) U.S. Cl. CPC G06Q 30/0278; A45C 11/18; A45C 13/008; A45C 2200/15; A45C 2200/10

(57) ABSTRACT

Improved protective cases for protecting collectibles and methods of use in an effort to reduce a likelihood of fraud. Identifiers can be provided directly onto collectibles, possibly not visible under normal lighting conditions, so that one may be able to identify if the collectible has been relocated to a different case with a different grade. Booklet and landscape cards can be displayed parallel to labels with certain embodiments.

### CLAIM OF PRIORITY

This application claims the benefit of U.S. Provisional application No. 63/251,783 filed Oct. 4, 2021, and U.S. Design patent application Ser. No. 29/806,829 filed Sep. 7, 2021, Ser. No. 29/807,690 filed Sep. 14, 2021, and Ser. No. 29/810,161 filed Oct. 1, 2021, all of which are incorporated herein by reference in their entirety.

### FIELD OF THE INVENTION

The present invention relates to protective cases for cards (commonly called “slabs”) for securing cards such as sports cards, gaming cards, and/or other collectable cards therein and a system of grading and labeling those cards and slabs.

### BACKGROUND OF THE INVENTION

Clear plastic cases known as “slabs” to house collectable cards particularly those cards which have been graded, i.e., evaluated as to their condition, have been well known in the industry for years. Becketts, GMA, HGA, PSA, ISA, SEC, and other companies typically grade cards on a 1 to 10 scale with 1 being the lowest and 10 being the best. The grade of a card typically affects the value of a particular card. The graded card is then typically secured shut in a slab in an effort to preserve the condition of the card in a clear plastic case (slab) along with a label which often identifies the grade, the grading service, and usually some basic information about the card. These plastic cases are not usually waterproof when they are shut.

Additionally, if someone is displeased with a grade they received on a card they could open the slab, send the card to either the same grading service or a different grading service and hope to receive a higher grade. It is well know that the higher grade a card receives, the more it is potentially worth.

As it relates to slabs, Becketts has obtained U.S. Pat. No. 6,295,750. The Applicant believes improvements can be had over prior art slabs in the marketplace.

There is also believed to be a need to provide a method for identifying particular cards which have been graded to reduce a likelihood of a regrade in an effort to receive a higher grade.

There is also believed to be a need to reduce the ability for persons to tamper with cards in slabs in an effort to provide an incorrect grade for a different card. For instance, if a person had a card that was graded at 9.5 (in extremely great condition) and a similar card graded at 8.5 (or something else) the party may be able to open the slab and swap the wrong card into that slab showing the higher grading. There is not believed to be an easy way to evaluate the correct grade of a card subjected to such fraud.

The Applicant believes improved methods to attempt to prevent such activity could be implemented in the marketplace.

### SUMMARY OF THE INVENTION

It is an object of many embodiments of the present invention to provide an improved card grading system possibly including a tamper resistant card identification system.

It is another object of many embodiments of the present invention to provide an improved system of identifying graded cards by providing an “invisible” marking on the card, the slab, and/or the label which are at least identifiable to the grading service, and may not be visible under ordinary lighting conditions.

It is another object of many embodiments of the present invention to provide an improved slab having a built-in stand.

It is another object of many embodiments of the present invention to provide an improved system of card tracking post grading.

It is another object of many embodiments of the present invention to provide inserts one of a plurality of options in slabs which not only relatively securely retain specific sized cards in the slab, but also may provide an indication if the slab has been the subject of tampering.

Accordingly, in accordance with presently preferred embodiments of the present invention an improved slab and grading methods are provided. The slab is not only aesthetically pleasing but also provides an ability to utilize one of a variety of inserts to receive differing thicknesses (and possibly length/width dimensions) of an inserted card, respectively. Cards are provided with different thicknesses (or other sizes) based on the manufacturer of the card and possibly the type of card. Different inserts receive differing thicknesses in a tray having a relative depth to accommodate the thickness of the card so that the card may touch a front cover of the slab while also touching a bottom surface of the tray of the insert. This can keep the card from being able to move within the insert and slabs. The insert itself may also be selected from a plurality of inserts so it is sized to a particular card style so that the edges of the card align with the sides of the tray of the insert to also inhibit movement of the card in the slab. The bottom of a top portion of a slab may cooperate with the insert to “sandwich” a card there between.

In addition to the improved insert system, many embodiments of the present invention also include a built-in stand which can extend outwardly to display the collectable card relatively effortlessly like a picture frame. When slabs are not displayed, the stand may be folded inwardly to a compact configuration. In a compact configuration, the stand preferably does not extend past a back or bottom surface of the slab (i.e., at or internal to perimeters defining the volume of the slab) to facilitate stacking, storage or other purposes.

While also grading on a scale, such as from 1 to 10, a grading label may be received internal to the slab in combination with an identifier which identifies the specific unique card in the slab. The same identifier may also be directly marked onto the graded card preferably in an invisible ink such as an ink which is visible with a UV (ultraviolet) or other light source. The slab may also be provided with this same identifying (preferably with invisible ink, as well). Accordingly, by shining the UV light on a slab, the three indicators if all utilized, can be seen and identified as to whether or not they match. If they do not match, then one would know that a counterfeit or a potential fraudulent situation has occurred. Other embodiments may have different numbers of identifiers.

The inserts utilized can not only hold the cards but also the labels in a secure fashion, so they do not move around in the slabs. These inserts may have a color signature that may change color when exposed to UV light preferably to a specific color which is utilized throughout the slab system so as to identify the origin of source as the applicant. Accordingly, by shing the light on any of the Applicant's slabs and onto the insert one would quickly know that the insert was provided by the Applicant.

These and other improvements can be provided with the various embodiments of the Applicant's invention.

### BRIEF DESCRIPTION OF THE DRAWINGS

The particular features and advantages of the present invitation will become apparent from the following description when considered in conjunction with the accompanying drawings in which:

FIG. 1 is a front perspective view of the presently preferred embodiment of the present invention in a compact configuration;

FIG. 2 shows the embodiment of FIG. 1 with the stand in an extended position as it would be supporting a card therein;

FIG. 3 shows a rear perspective view of the extended stand;

FIG. 4 shows a rear plan view of the case in a compact configuration;

FIG. 5 shows a rear plan view of the case with the stand in a compact configuration;

FIG. 6 shows a cross sectional view with the first insert;

FIG. 7 shows a perspective view of a first alternatively preferred embodiment; and

FIG. 8 shows a perspective view of a second alternatively preferred embodiment.

### DETAILED DESCRIPTION OF THE PREFERRED EMBODIMENT

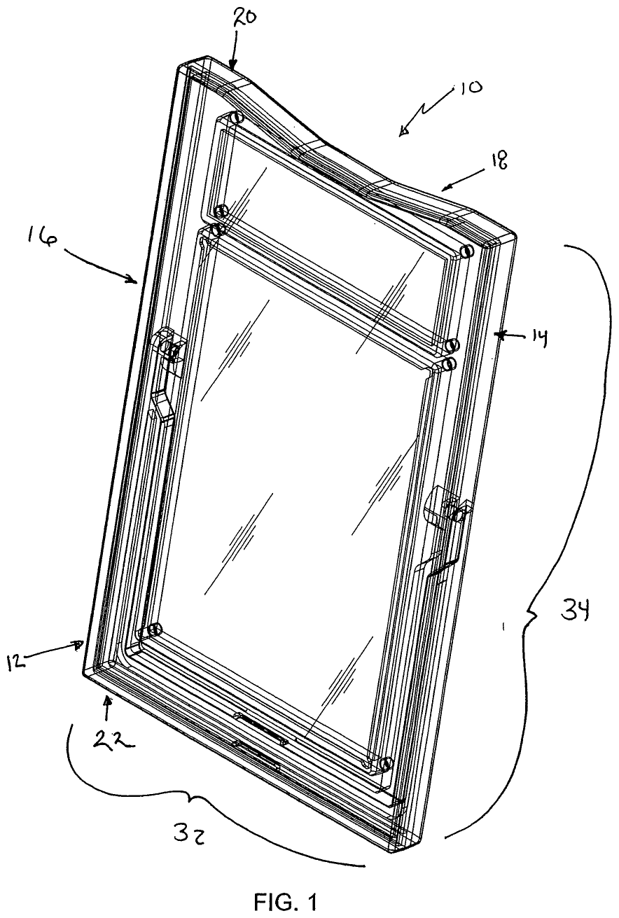

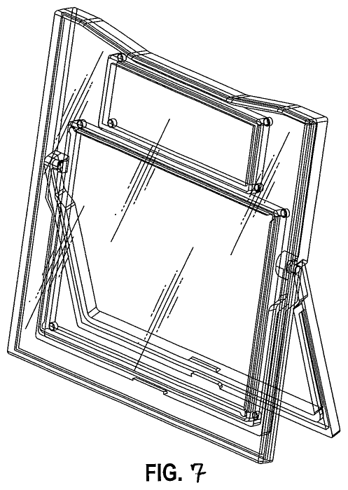

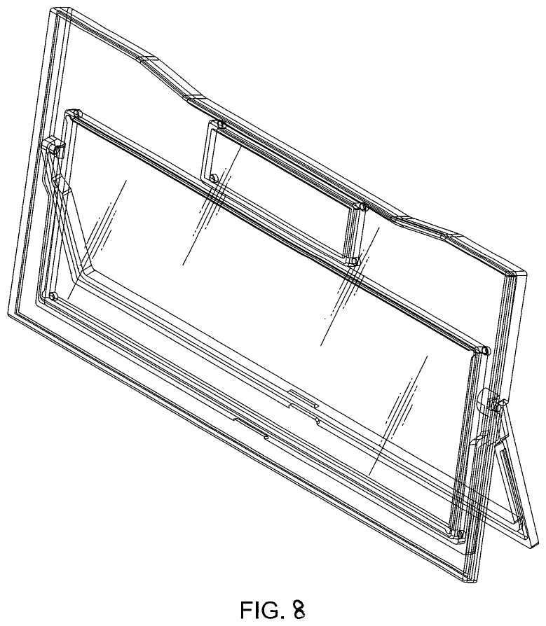

FIG. 1-6 show various uses of the preferred embodiment of the present invention. FIG. 1 shows a protective case, also known as a slab 10, to which is typically manufactured of a transparent material such as acrylic although carbon-polycarbonate and other materials certainly have been utilized in the past. Other plastics and/or other materials may be utilized with various other embodiments. The case preferably has a front 12 sides 14,16 and a rear 18 a top 20 and a bottom 22. A slab 10 tends to preferably be manufactured in two pieces with a top portion 24 which is preferably ultrasonically welded or otherwise secured to a bottom portion 26 which is shown in FIG. 6. It is preferred that the connection of the top portion 24 with the bottom portion 26 be water-tight for many embodiments so as to further protect the card inserted into the slab 10. Ultrasonically welding the exterior contact points of the top and bottom portions 24,26 can accomplish this feature for some embodiments.

For ease of illustration and understanding, all of the figures except for FIG. 6 are shown empty with FIG. 6 showing a card 28 and a label 30 inserted into the slab 10.

Although a portrait style slab 10 is shown, other embodiments may have a longer width 32 than the one illustrated and possibly a shorter height 34 so as to accommodate landscape oriented cards and some still others may have even a wider width 32 to accommodate booklet style cards. Accordingly, it is visioned that a number of configurations can be provided as slabs 10 will be provided to the marketplace potentially with each potentially having at least one, if not a respective set of inserts 36, to accommodate various thicknesses (and possibly height and width) of cards 28 as will be discussed in further detail below.

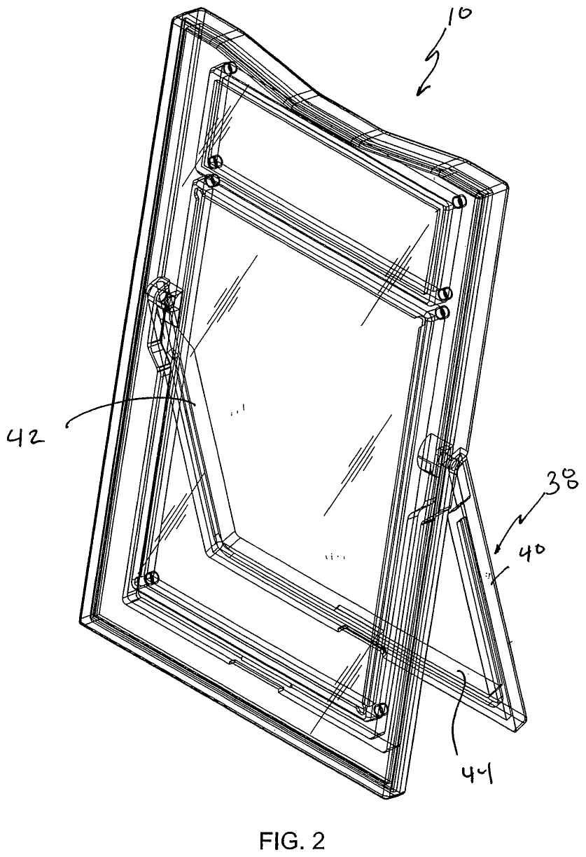

FIG. 2 shows the stand 38 extended rearwardly relative to slab 10. Stand 38 may have legs 40,42 possibly connected by a base 44.

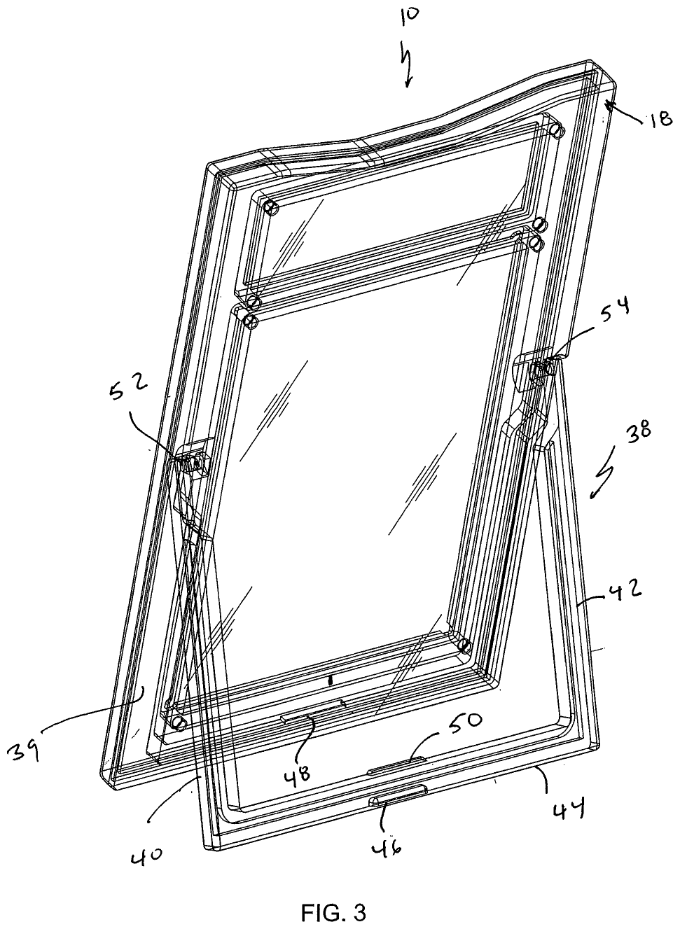

Retention members 46,48 may cooperate with one another to hold the stand 38 in a shut configuration or in a compact configuration as shown in FIG. 1. When closing, such as by pushing the legs 40,42 and or base 44 towards the rear 18 of the slab 10, the retention members 46,48 cooperate to at least temporarily prevent outward motion of the stand 38, once engaged. One may then pull on the assist 50 to disengage retention members 46,48 from one another to assist in extending the stand 38 such as is shown in FIG. 3 as would be understood by those of ordinary skill in the art. The legs 40,42 may be connected at pivots 52,54 to pivot between configurations or the stand 38 may be otherwise operably coupled to the slab 10. Stand 38 nests within pocket 39 in a preferred embodiment in the closed configuration.

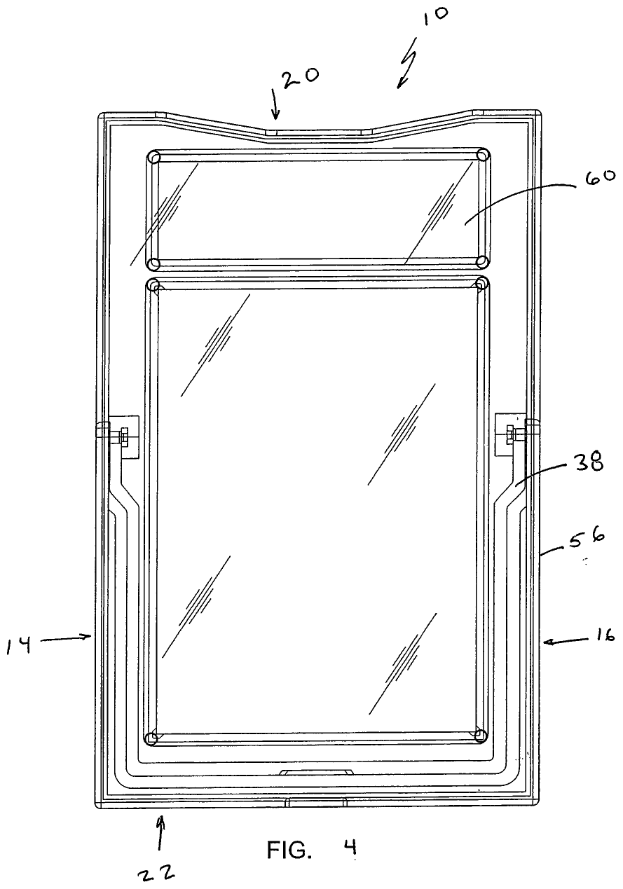

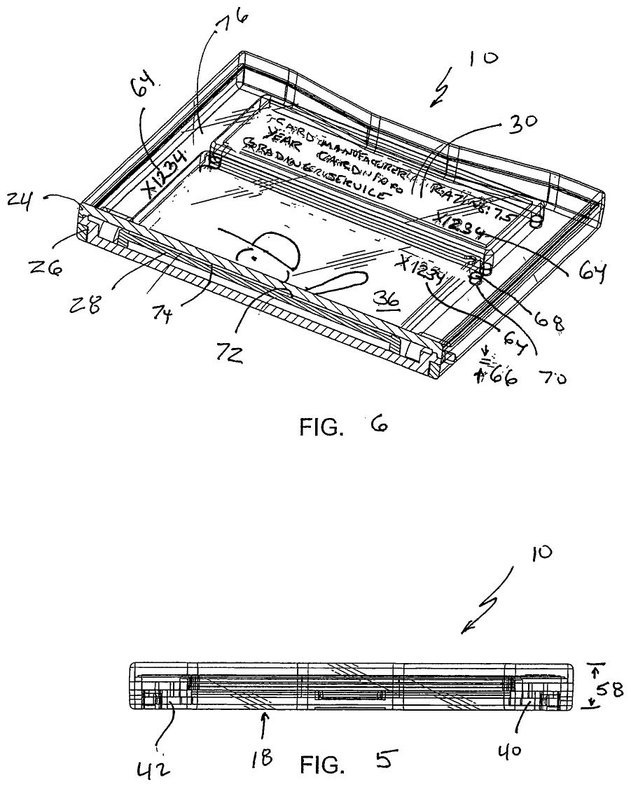

FIG. 5 shows the legs 40,42 located above the rear 18 of the slab 10 when in the compact configuration and FIG. 4 shows the stand 38 located internal to a perimeter 52 of the slab 10 such as taken from the top 20, sides 14,16, and bottom 22. The stand 38 preferably extends no farther than a maximum perimeter of the thickness 58 of the slab 10 and not beyond the perimeter 56. Due to the rectangular nature of the box like shape of the slab 10, for many embodiments multiple slabs can easily be stacked on top of one another and/or placed flat on their rear 18 when so desired so that the stand 38 preferably does not interfere with a planar rear 18 and/or stacking when in the compact configuration.

While some embodiments may enjoy the built-in stand 38, these and/or other embodiments may have other features. Specifically, a tamper resistant label system may be applied in various ways. When the card 28 is provided to the Applicant, the Applicant grades the card. That grade is provided on a label 30 which is provided in a label tray 60 which may be its own separate (second) insert or it may be a part of the (first) insert 36 which receives the card 28. For every card graded, the Applicant preferably assigns a unique identifier, such as a certification number 64, but can certainly take other forms such as alpha numeric indications, be QR codes, or other indicators which could be a unique identifier for that particular card 36. That same identifier or certification number 64 could be provided on the card 36, the label 30 and/or on the slab 10 so that there could be a two or three way authentication process to determine if the correct card 36 is matched with the correct label 30 and/or the correct slab 10.

The identifier or certification number 64 could be provided in invisible ink so as not visible under normal lighting conditions but may display under UV or other light or other appropriate condition to provide such capability. The label 30 could also be made to disintegrate if the slab 10 were opened by potentially adhering to both top and bottom portions 24,26 at least in the area of the certification number 64 as well as the label 30. Other methods known in the art could assist in damaging the label 30 if the slab 10 were opened as a tamper indicator. The unique indication or certification number 64 is shown on the card 36 and on the slab 64. This way if the indicators or certification numbers 64 do not match, one will know that fraudulent activity possibly has occurred.

Also, a user or other party can potentially look up the certification number 64 at a website of the Applicant or other party. Since the certification number 64 is known in the art to identify the particular card 36, information can be provided to viewers including the grade of that card 36. Also, if that card 36 were to be sent back in to be regraded, the same or a lower grade could be provided to a submitting party since its past grade would be known. A grade history could be provided from multiple grading efforts. It may or may not be advertised that the certification number 64 appears on the card 36 so that the owner may or may not know about the certification number 64. When the certification number 64 appears on the label 30, the owner or other party could look up the number (once viewed in a visible (or invisible) format) such as at the Applicant's website if desired. Additionally, the insert 36 may be provided from a resin infused with a color signature that may change under exposure to specific wave lengths of light such as UV light. This changing color may change to a specific color that may be uniform throughout the Applicant's slabs 10.

The insert 36 (which may be one of a set of possible selections for a particular slab 10) preferably has a card tray 62 having a depth 66 as shown in FIG. 6. Different inserts 36 may have different depths 66 to accommodate different thicknesses of cards 36. The height and width of the inserts 36 may also be varied to accommodate different of the card trays 62 may also be varied for various cards. As shown in the illustrated embodiments, the insert 36 may have feet 68 which cooperate with bores 70 in the bottom portion 26 of the slab 10 to potentially securely locate the inserts 36 in a desired position so they do not move. Sizing of the inserts 36 to fit in slabs 10 could also assist in this locating feature. Furthermore, the card tray 64 is preferably selected to cooperate with a specific card 28 so that the card does not move from side to side or from top to bottom or front to back and is preferably sized so that it contacts the bottom 72 of the card tray 62 as well as the bottom surface 74 of the top portion 24 of the slab 10 to be “sandwiched” so that the insert 36 and bottom surface 74 of the top portion 24 of the slab 10 secures the card 28 from movement when inserted 20 pt to 360 pt thicknesses have been used with initial embodiments. After inserting the card 28 in the insert 26 with the label 30 applied in the label tray 60, the top portion 24 is then preferably secured and/or sealed to the bottom portion 26. The slab 10 preferably displays the certification numbers 64 as applied to the card 28, the label 30 and/or the slab 10 such as on a facing portion 76 of the bottom portion 26 or other appropriate portion. Invisible (UV sensitive) or other inks (visible or not) may be used with at least some of the certification numbers 64.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the intention are intended to be included within the scope of the appended claims.

Having thus set forth the nature of the invention, what is claimed herein is:

1. A method for use with graded collectibles comprising the steps of:
a. grading a specific collectible relative to a scale with a first grade on a first date;
b. providing a unique identifier with the collectible;
c. displaying the first grade on a label retained within at least partially transparent protective case surrounding the collectible within a volume with the identifier;
d. correlating the identifier with the first grade in a database; and then
e. a party viewing the identifier having the database accessed to verify that the collectible received the first grade.

2. The method of claim 1 wherein when during the step of accessing the database verifying the first date of the first grade.

3. The method of claim 1 wherein when during the step of accessing the database verifying the identifier is correlated with a second grade received on a second date before the first date, and the party viewing the identifier verify the first and second grades.

4. The method of claim 3 further comprising the step of verifying the first grade is no higher than the second grade.

5. The method of claim 1 further comprising the step of securing the volume of the protective case closed with the label being a tamper resistant label, and further comprising the step of the label being at least partially destroying simultaneously with opening of the protective case.

6. The method of claim 1 further comprising the step of adhering the label to a portion of the protective case, whereby upon opening the display case, at least a portion of the label is at least partially destroyed.

7. The method of claim 6 further comprising the step of providing a label tray in the volume, and adhering a portion of the label to the label tray.

8. The method of claim 1 wherein during the step of accessing the database, the party accesses a publicly accessible database.

9. The method of claim 1 wherein during the step of grading the collectible, the collectible is a trading card.

10. The method of claim 9 wherein during the step of grading the trading card, the trading card is a sports trading card.

11. The method of claim 10 wherein the at least partially transparent display case is oriented to display one of landscape and booklet trading card orientations, and further comprising the step of locating a label in the transparent case with text parallel to a longest perimeter side of the display case.

12. The method of claim 1 wherein during the step of providing the identifier, the unique identifier is a certification number.

13. The method of claim 1 wherein during the step of providing the identifier, the identifier is invisible under normal lighting conditions and is provided directly on a surface of the collectible.

14. A method for use with graded collectibles comprising the steps of:
a. grading a specific collectible card relative to a scale with a first grade on a first date;
b. preparing a label having at least the first grade;
c. inserting the label and collectible card within an at least partially transparent protective case surrounding the collectible card and label within at least one volume whereby the label has text oriented parallel to a longest perimeter side of the display case with the collectible card in one of a booklet and landscape orientation in the at least partially transparent protective case.

15. The method of claim 14 further comprising the step of associating a unique identifier with the collectible card and providing the unique identifier on the label.

16. The method of claim 14 further comprising the step of additionally providing the unique identifier directly on the collectible card.

17. The method of claim 15 further comprising the steps of:
a. correlating the identifier with the first grade in a database; and then
b. a party viewing the identifier having the database accessed to verify that the collectible received the first grade.

18. A protective case for use with collectibles comprising:
a. a top and bottom portion, that when connected together provide a front, rear, back, sides, top and bottom having a volume therein with the sides having a shorter length than the top and bottom;
b. a collectible card having a width greater than a height when upright at least partially retained in the volume, and a length of the top and bottom of the protective case is longer than a length of the sides to provide one of a landscape and booklet configuration.
c. a label associated with the collectible card located within the volume having text oriented parallel to the width of the card and the bottom of the protective case.

19. The protective case of claim 18 further comprising a first insert having a card tray, the card tray receiving the collectible card within the volume and encapsulated therein by the protective case.

20. The protective case of claim 19 further comprising a label insert supporting the label within the volume.
